(19) United States
(12) Patent Application Publication
(10) Pub. No.: US 2008/0114273 A1
(43) Pub. Date: May 15, 2008

(54) Method for determining the stimulated point of human body

(76) Inventor: Shan-Chi Ko, Taipei City (TW)

Correspondence Address: BIRCH STEWART KOLASCH & BIRCH, PO BOX 747, FALLS CHURCH, VA, 22040-0747, US

(21) Appl. No.: 11/889,134

(22) Filed: Aug. 9, 2007

(30) Foreign Application Priority Data
Nov. 15, 2006 (TW) 095142299

(51) Int. Cl. A61H 99/00

(52) U.S. Cl. 601/1

(57) ABSTRACT

The present invention discloses a method for determining the stimulated point of human body. The present invention includes defining the distributions of the plurality of collateral meridians of human and the plurality of body flow lines, thereby constructing the related information regarding the collateral meridians and the body flow lines based on the distributions of the plurality of collateral meridians and body flow lines, identifying the corresponding body flow lines based on the collateral meridians of the abnormal portions, determining one or a plurality of stimulated points based on the body flow fines and the corresponding information on abnormal positions, and applying the stimulations to the stimulated points for attenuating or recovering the abnormal portion.

### BACKGROUND OF THE INVENTION

1. Field of the Invention

This invention relates to a method for determining the stimulated point, and more particularly to a method for determining the collateral meridian stimulated point of human body, combining the theories of Chinese medicine and modern medicine and seasonal factors. The stimulated points are determined according to the collateral meridian stimulated point of human body, and then the stimulations are applied to attenuate or recover the abnormal portions.

2. Description of the Prior Art

Recently, medical science and technology have developed, and individuals live at a frantic pace with hectic lifestyles. Most individuals spend a lot of time on work, but have little time left over for exercise or travel. However, a few people still manage to maintain good health. Discomfort or pain is generally unavoidable with increasing age. People lack sufficient time to treat or attenuate the pain syndrome resulting in a situation where recovery becomes impossible.

Previously, people faced risks from numerous diseases. During the last several thousand years, people have been devoted to solving the problems of people's birth, age, illness and death in an effort to fight various diseases. For example, headache, shoulder and neck pain, toothache, backache and knee pain are included in the pain syndromes. Despite science and technology rapidly changing, pain remains unavoidable. Because human life generally begins with labor pains left by the mother and ends with various diseases, people must face and overcome physiological or psychological pains throughout their lives. Although some people have good resistance to pain, most people do a poor job.

Generally, when experiencing discomfort or pain, people may seek modern medical treatment because medicine or injections can be used to treat pain directly. However, treatments can provide a temporary rather than a permanent solution to attenuating the pain. Some people may undergo the Chinese medical treatment, but their symptoms are likely to take a long time to improve in this case. Treatment methods and times differ markedly between Chinese and modern medicine, and it is different to select one from them. Furthermore, the pain syndrome is a form of abnormal portion in human body. It is urgently necessary to attenuate, improve or eliminate the pain quickly and effectively.

Moreover, in modern medicine, certain medicines, such as an anodyne or an anaesthetic, are always used in treatment, and their use may be accompanied by unexpected side effects, complications or sequelas. Similarly, in Chinese medicine, the acupressure and massage may attenuate the muscle pain but cannot be employed to treat the acute pain syndrome. However, it is worse to provide the treatment of the acupressure or the massage directly on the pain portion with inflammation. To avoid the increased inflammation, people should carefully select the most appropriate treatment. People may be advised reconsider the acceptable treatments for different types and portions of pain syndrome.

Based on the above, the present invention provides a new method for determining the stimulated point on the human body to overcome the above disadvantages of prior art. The method of the present invention is developed by amending and combining the Chinese and modern medicine theory to attenuate or recover the abnormal portions, and can be modified according to different requirements.

### SUMMARY OF THE INVENTION

The present invention illustrates preferred embodiments as follows. However, it is appreciated that the present invention can extensively perform in other embodiments except for these detailed descriptions. The scope of the present invention is not limited to these embodiments and should be accorded the following claims.

One objective of the present invention is to provide a method for determining the stimulated point of human body, which provides a new aspect of five dimensions to replace with two dimensions method.

Another objective of the present invention is to provide a method for determining the stimulated point of human body, where the stimulations can be applied according to the user's requirements.

Still another objective of the present invention is to provide a method for determining the stimulated point of human body, which can offer the appropriate stimulation to attenuate or recover the abnormal portion rather than perform the treatment directly on the pain portion.

Yet another objective of the present invention is to provide a method for determining the stimulated point of human body, which is based on the combination of amended theories of the Ying-Yang and the five element, 12 collateral meridians, the relationship of inter promotion and inter-restrict of Chinese medicine and pathologic physiology of modern medicine.

The present invention provides a method for determining the stimulated point of human body comprising defining the distributions of a plurality of collateral meridians in human and a plurality of body flow lines; constructing the related information regarding the collateral meridians and the body flow lines based on the distributions of the plurality of collateral meridians and the body flow lines; identifying the corresponding body flow lines based on the collateral meridians of abnormal portions; determining one or a plurality of stimulated points based on the body flow lines and the corresponding information of abnormal positions; and applying the stimulations to the stimulated points for attenuating or recovering the abnormal portions.

### BRIEF DESCRIPTION OF THE DRAWINGS

The foregoing aspects and many of the attendant advantages of this invention will become more readily appreciated as the same becomes better understood by reference to the following detailed description, taken in conjunction with the accompanying drawings, wherein:

FIG. 1 illustrates a flow chart of a method for determining the stimulated point of human body according to the present invention;

FIG. 2A illustrates a diagram of the body flow lines of human body that partially blocked according to the present invention;

FIG. 2B illustrates a diagram of the body flow lines of human body that completely blocked according to the present invention;

FIG. 3 illustrates a diagram of a theory of Ying-Yang and six elements which is amended based on Ying-Yang and the five elements of Chinese medicine according to the present invention;

FIG. 4 illustrates a diagram of a hexagonal relation for determining the stimulated point of human body according to the present invention;

FIG. 5 illustrates a diagram of a seasonal relation for determining the stimulated point of human body according to the present invention;

FIG. 6A illustrates diagrams of the external body flow lines of left and right hands of human body according to the present invention;

FIG. 6B illustrates diagrams of the internal body flow lines of left and right hand of human body according to the present invention;

FIG. 7A illustrates diagrams of the external body flow lines of left and right feet of human body according to the present invention;

FIG. 7B illustrates diagrams of the internal body flow lines of left and right feet of human body according to the present invention;

FIG. 8A illustrates a diagram of the visual analogue scale (VAS) scores over time for pre-stimulation, post-stimulation and pills treatment according to the second embodiment of the present invention;

FIG. 8B illustrates a diagram of the three-phase bone scan before the stimulation according to the second embodiment of the present invention; and

FIG. 8C illustrates a diagram of the three-phase bone scan after the stimulation according to the second embodiment of the present invention.

### DESCRIPTION OF THE PREFERRED EMBODIMENT

In the following description, numerous specific details are provided in order to give a through understanding of embodiments of the invention. Referring now to the following description wherein the description is for the purpose of illustrating the preferred embodiments of the present invention only, and not for the purpose of limiting the same. One skilled in the relevant art will recognize, however, that the invention may be practiced without one or more of the specific details, or with other methods, components, materials, etc.

Referring now to the drawings and the following description wherein the showings and description are for the purpose of illustrating the preferred embodiments of the present invention only, and not for the purpose of limiting the same. Then, the drawings of different elements are not shown to scale. Some dimensions of the related elements are exaggerated and meaningless portions are not drawn to provide a more clear description and comprehension of the present invention.

The present invention discloses a method for determining the collateral meridian stimulated point on the human body. The proposed method is based on the theories of the Ying-Yang and the five elements, as well as 12 collateral meridians, and the relationship between inter promotion and inter-restriction of Chinese medicine and the pathological physiology of modern medicine. The present invention provides a five dimensional method for determining the related corresponding body flow lines, as follows. Notably, the body flow lines in the present invention differ from the collateral meridians mentioned by the Chinese medicine. Therefore, one of the characteristic of the present invention is the body flow lines on the human body and their definitions. The body flow lines include mobilizing or circulating molecules, such as various ions, neurotransmitters, lymph and blood.

Based on the aspect of the present invention, the “collateral meridians” describe the division of the human body longitudinally and horizontally. The cross sections between the longitudinal and horizontal lines are called the collaterals. Most of the longitudinal lines are distributed in the human body, and therefore, the body can be divided into a plurality of collateral meridians distributed throughout the human body. Furthermore, various body flow lines can be found in various systems of internal organs in humans including circulatory system, digestive system, respiratory system, nervous system and urinary system. The body flow lines include various materials or molecules mobilizing or circulating throughout the human body. For example, the materials or molecules including blood, lymph, neurotransmitters, autacoid secreted by the endocrine gland, ions, air, and water. Corresponding relationships exist among the above systems, and the communication among them can present as the plurality of body flow lines. The relationships between collateral meridians and body flow lines thus can be corresponding or relative. Based on continuous efforts and research, the present invention is developed and defined by the Applicant. The related articles and information may refer to Ko et al., Acta Anaesthesiol Taiwanica, 44:59-60 (2006), entitled “Can we do better, in addition to the pharmacological treatment, on pain: Collateral Meridian Therapy” and Ko et al., Anesthesia & Analgesia, 103(6), entitled “Collateral Meridian Therapy dramatically attenuates pain and improves functional activity of a patient with complex regional pain syndrome”. The articles are incorporated herein for reference. The references provide related information regarding the importance, utility and reappearance of the present invention.

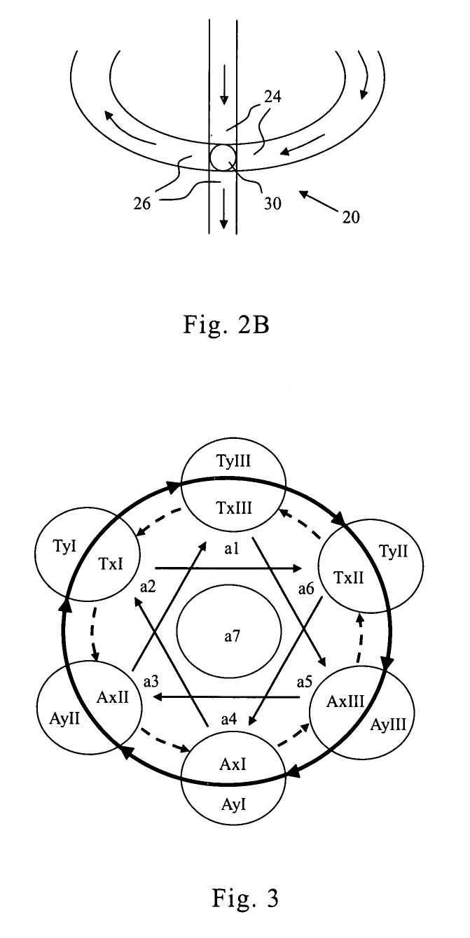

However, FIGS. 2A and 2B show that the abnormal portion of human body generated when one cross section 20 of the body flow lines is blocked by obstruction 30. According to the present invention, the type of abnormal portion includes dull pain, sharp pain or numbness, and the generation of the abnormal portion is serves as an alarm signal reflecting or indicating the abnormal physical condition. Notably, the generation of the abnormal portion is not a disease, and thus the present invention is not a diagnostic or treatment method. The above conditions are abnormal and can be attenuated or improved by the present invention.

FIG. 2A diagrammatically illustrates a cross section 20 of the body flow lines that are partially blocked by the obstruction 30 according to the present invention. When the cross section 20 is partially blocked, the mobilizing or circulating molecules cannot easily pass through body flow line channels. Individuals may then experience dull or sharp pain generated at the muscle corresponding to the previous portion 22 of the blocked section 24. FIG. 2B diagrammatically illustrates a cross section 20 of the body flow lines that completely blocked by the obstruction 30 according to the present invention. When the cross section 20 is completely blocked, the mobilizing or circulating molecules cannot pass through the body flow line channels. Individuals thus may experience the numbness generated at the muscle corresponding to the portion 26, following the blocked section 24. These pains are abnormal appearances.

Given the abnormal appearance, if the blocked cross portion 20 can communicate with the other related corresponding body flow lines and the appropriate stimulations are performed, the abnormal appearance can be attenuated or recovered. Therefore, to rapidly and effectively attenuate or recover the abnormal portion, the present invention can determine the collateral meridian stimulated points on the human body.

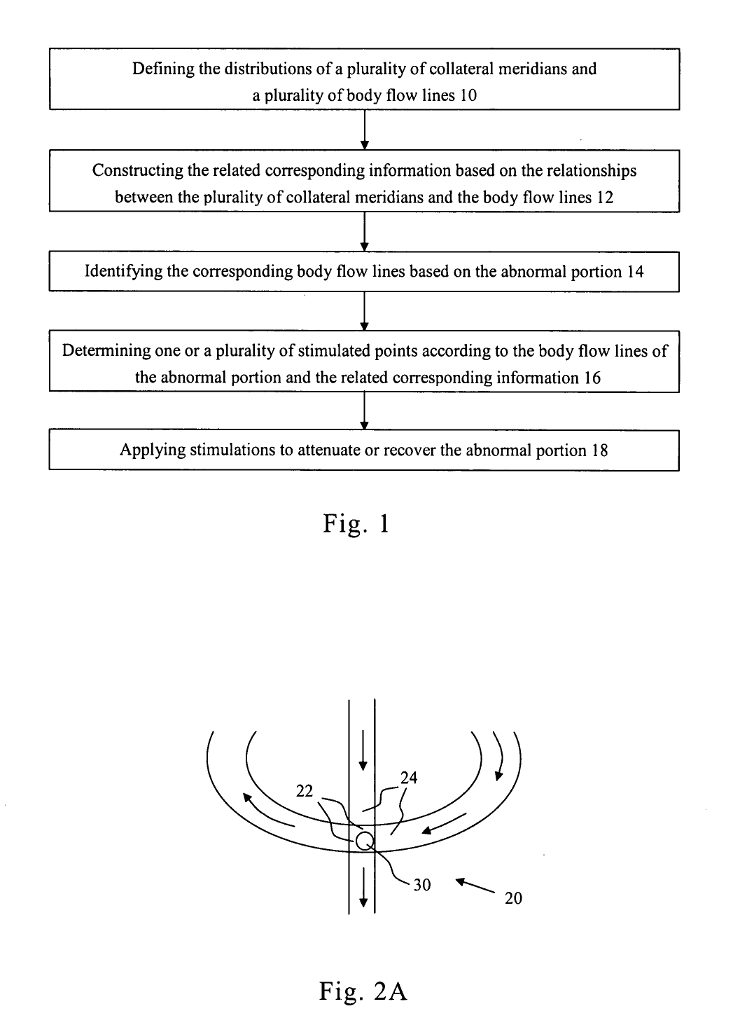

Referring to FIG. 1, it is a flow chart of a method for determining the stimulated points of the human body according to the present invention. The method comprises defining the distributions of the plurality of collateral meridians of humans and the plurality of body flow lines, as illustrated in step 10. Related information regarding the collateral medians and the body flow lines can then be constructed based on the distributions of the plurality of collateral meridians and body flow lines, as illustrated in step 12. The corresponding body flow lines can be identified according to the collateral meridians of the abnormal portions, as illustrated in step 14. Subsequently, one or a plurality of stimulated points can be determined based on the body flow fines and the corresponding information of abnormal positions, as illustrated in step 16. Specific points thus can be stimulated to achieve alleviation or recovery of the abnormal portion, as illustrated in step 18.

In one embodiment, the human collateral meridians are divided into a plurality of collateral meridians longitudinally and horizontally. One or a plurality of body flow lines are the networks that communicate with the plurality of human collateral meridians.

According to the aspect of the present invention, the human body flow lines include Ying and Yang body flow lines. The Ying body flow lines comprise the internal portions of the human body, such as the ventral region, and the internal organs of human, such as, the liver, lung, kidney, heart and spleen. Meanwhile, the Yang body flow lines comprise the external portions of human body, including the dorsal regions of human, the external portions of the left and right hands, the external portions of left and right feet, and the external organs of human, including the stomach, urchin, bladder and large and small intestine.

In one embodiment, the types of abnormal portions include chronic and acute abnormal portions, and local and central abnormal portions. For example, the central region includes the internal organs of human body, and the local region includes the limbs or trunk and the body.

In one embodiment, the abnormal portion includes the regions that are sensing certain feelings, including pain. The abnormal region can cover the head, the limbs or trunk or the body, and the visceral organs or nervous system of human body.

In a preferred embodiment, the step sequences are used to illustrate rather than limit the present invention. It is noted that the present invention can be modified and changed according to the different user's requirements.

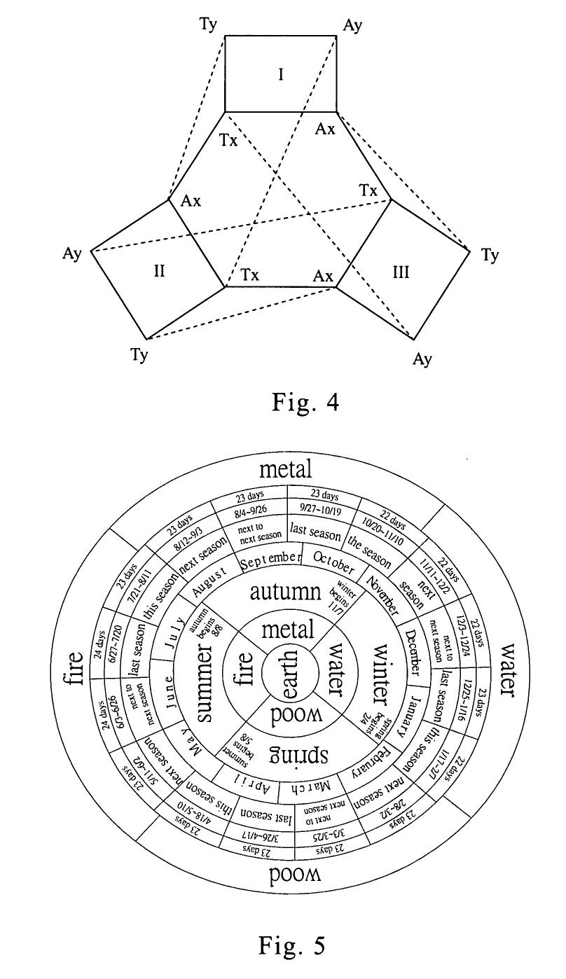

According to the aspect of the present invention, the distributions of the plurality of collateral meridians of humans and the plurality of body flow lines and one or the plurality of stimulated points are based on the corresponding or (relative) opposite relationships among the theories of the Ying-Yang and the five element shown in FIG. 3, the hexagonal relation shown in FIG. 4 and the seasonal time shown in FIG. 5.

FIG. 3 diagrammatically illustrates an amended theory of Ying-Yang and six elements based on the Ying-Yang and five elements of Chinese medicine according to the present invention. The illustrated method determines the stimulated points according to the amended theory. In FIG. 3, the references a1, a2, a3, a4, a5, a6, a7, are respectively labeled fire, metal, wood, earth, water, govern fire, air. Moreover, the references T and A are respectively represent the hands (the Japanese word for “hand” has a similar pronunciation [Te]) and feet (the Japanese word for “foot” has a similar pronunciation [Ashi]), and the references r and l respectively denote right and left. Additionally, the references x and y are respective indicate the Ying and Yang body flow lines, and each body flow line has three body flow lines, I, II and III. For examples, “TyIII” indicates that the Yang body flow lines III occupies the external portions of hands, “AxI” means that the Ying body flow lines I occupies the internal part of the foot, and “rTxI” denotes that the Ying body flow lines occupy the internal portion of the right hand.

In one embodiment, TxI denotes the lung meridian, while TxII represents the pericardium meridian, TxIII is the heart meridian, TyI denotes the large intestine meridian, TyII represents the three jiaos meridian, and TyIII is the small intestine meridian. Similarly, AxI denotes the spleen meridian, AxII represents the liver meridian, AxIII is the kidney meridian, AyI denotes to the stomach meridian, AyII represents the urchin meridian and AyIII is the bladder meridian.

Furthermore, refer to FIG. 3, the clockwise circulation relation in the outer cycle refers to the inter promotion relationship of the Ying-Yang and the five elements. For example, water generates earth and wood generates fire. The inter promotion relationship also can be termed as a mother-son relationship. The anti-clockwise circulation relation in the inner cycle is the inter-insult relation, for example that fire cannot go out when there is a lack of water. The central hexagon circulating relation is the inter-restrict relation, for example that metal can be melted by fire, wood can be pared by metal, earth can be covered by wood, and water can be absorbed by earth.

FIG. 4 shows a diagram of a hexagonal relationship for determining the stimulated point on the human body according to the present invention. The dotted lines in FIG. 4 are indicated that the communications or relationships between the inter promotion relation and the corresponding relations based on the experimental data. In the drawing, the solid lines connecting the peripheral rectangles with the central hexagon indicate the inter-general relations among the body flow lines of Tx, Ty, Ax, Ay, I, II and III. Meanwhile, the dotted lines indicate the corresponding relationships among the body flow lines of Tx, Ty, Ax, Ay, I, II and III. For example, if the abnormal portion is generated at the body flow line TyI, the corresponding body flow line can be indicated as AxII based on the dotted line between TyI and AxIl. Furthermore, if the abnormal portion is generated at the body flow line AyII, the corresponding body flow line can be indicated as TxIII based on the dotted line between AyII and TxIII.

In one embodiment, after identifying the corresponding body flow lines of the abnormal portions, the defined and related corresponding body flow lines are used to determine one or a plurality of stimulated points on the human body. Please review the following descriptions.

The distributions of body flow lines vary slightly with seasonal changes, and their properties and definitions also vary. For examples, the blood vessels expanded in summer and constrict in winter. Therefore, the present invention introduces the factors of the seasons and days to provide the proper and accurate information for determining the stimulated points of the human body for effectively attenuating or recovering the abnormal portion. FIG. 5 illustrates a diagram of a seasonal relation for determining the stimulated point of the human body according to the present invention. The drawing respectively refers to wood, fire, metal, water and earth as the seasons of spring, summer, autumn and the eighteen days before the beginning of spring, the beginning of summer, the beginning of autumn and the beginning of winter. The govern fire shown in FIG. 3 is termed the plum rains. Accordingly, the present invention provides a five-dimension method for determining the stimulated point of the human body for effectively attenuating or recovering the abnormal portion.

In one embodiment, if the blocked portion is generated at the body flow lines TxI and TyI, the pain will appear in autumn (corresponding to metal, as shown in FIG. 5), such as the Radial nerve lesion in the thumb or the forefinger. Consequently, if the suitable and accurate stimulations are offered in autumn, it may take a long time to attenuate or recover the pain portion, and the pain portion will appear frequently. If the proper stimulations are offered excluding the autumn, it is easy to attenuate or recover the pain portion.

In one embodiment, if the blocked portion is generated at the body flow lines AxIII and AyIII, the pain will appear in winter (corresponding to water, as shown in FIG. 5), with examples including lumbago and pains in the vertebra (such as the cervical vertebra, the lumbar vertebra and the caudal vertebra). Therefore, if the appropriate and accurate stimulations are offered in winter, it may take a long time to attenuate or recover the pain portion, and the pain portion will frequently appear. If the appropriate stimulations are offered excluding the winter, it may be easy to attenuate or recover the pain portion.

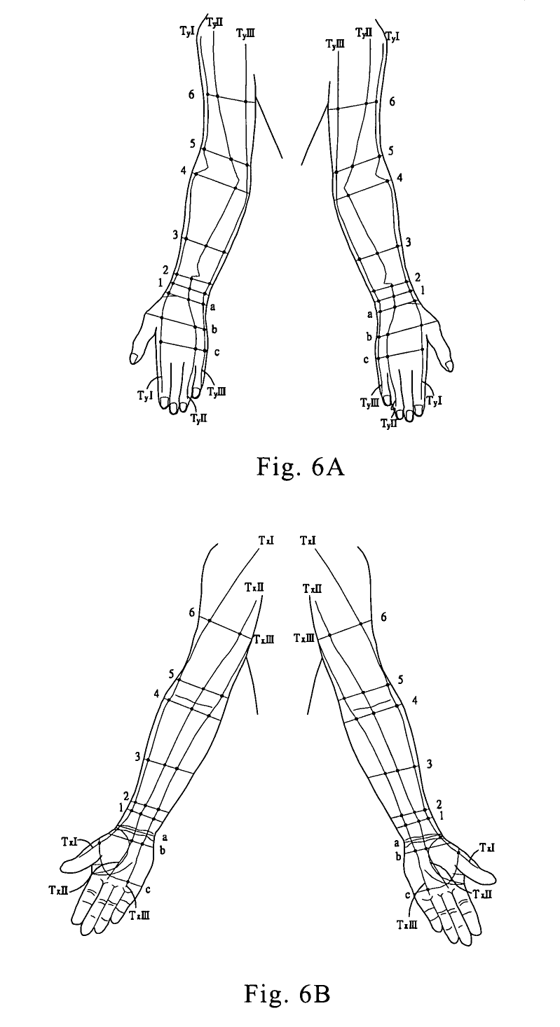

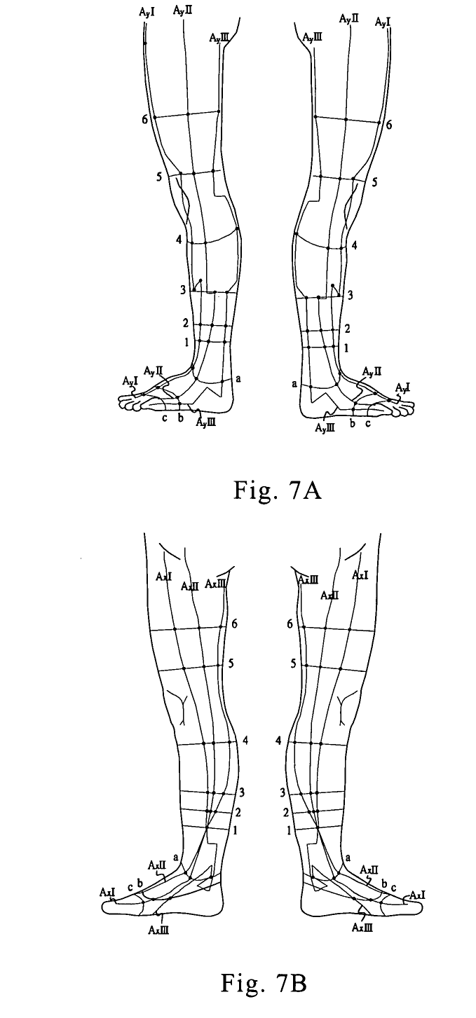

According to the aspects of the present invention, the distributions and definitions of the collateral meridian stimulated points are determined by the related information in FIGS. 6A and 6B and FIGS. 7A and 7B.

Refer to FIG. 6A, it illustrates diagrams of the external body flow lines of the left and right hands of the human body according to the present invention. FIG. 6B illustrates diagrams of the internal body flow lines of the left and right hand of human body according to the present invention. In FIGS. 6A and 6B, the internal body flow lines TxI, TxII, TxIII of the left hands and the external body flow lines TyI, TylI, TyIII of the right hands are respectively divided into a plurality of stimulated points. In the drawing, the body flow lines are divided into six stimulated points, 1, 2, 3, 4, 5, 6, at the upper elbow of the hand and three stimulated points, a, b, c, below the elbow of the hands. Accordingly, each body flow line of the hand can be divided into the nine stimulated points, a, b, c, 1, 2, 3, 4, 5, 6, as shown in FIGS. 6A and 6B.

Moreover, refer to FIG. 7A, it illustrates diagrams of the external body flow lines of the left and right feet of human body according to the present invention. FIG. 7B illustrates diagrams of the internal body flow lines of left and right feet of human body according to the present invention. In FIGS. 7A and 7B, the internal body flow lines AxI, AxII, AxIII of the left feet and the external body flow lines AyI, AyII, AyIII of the right feet are respectively divided into a plurality of stimulated points. In the drawing, the body flow lines are divided into three stimulated points, a, b, c, below the ankle and six stimulated points, 1, 2, 3, 4, 5, 6, above the ankle. Accordingly, each body flow line of the foot can be divided into the nine stimulated points, a, b, c, 1, 2, 3, 4, 5, 6, as shown in FIGS. 7A and 7B.

In one embodiment, based on the above aspects, each individual has 12 body flow lines distributed in the left and right hands and left and right feet, and therefore, resulting in the provision of 108 stimulated points according the present invention. Notably, the numbers and the positions of the body flow lines and the stimulated points are described for illustrating rather than to limit the present invention. The numbers and the positions of the body flow lines and the stimulated points can be modified according to the different conductions requirements.

In one embodiment, the stimulated points are the portions corresponding or relative to the pain portions. The relations can be obtained from the above definitions and determination method.

According to the aspect of the present invention, the plurality of stimulated points includes control stimulated points (C points) and function stimulated points (F points). In one embodiment, the C points indicate the stimulated points between the plurality of the stimulated points, while the F points refer to the stimulated points used to attenuate or recover the abnormal portions.

In one embodiment, the stimulations include the acupressure, massage, acupuncture, electric stimulation (ES), laser or the improved chemical or natural articles. The improved chemical or nature articles can be used externally or internally.

In one embodiment, the duration and frequency of the stimulation may be several times per days and lasting for a few minutes each time. Meanwhile, the duration and frequency of the stimulation can be modified and changed to fit user's requirements.

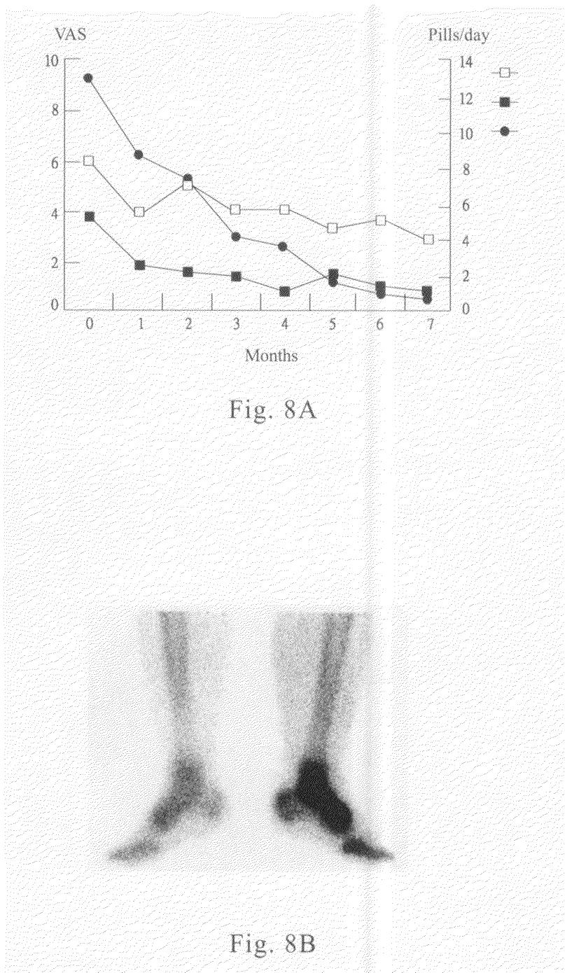

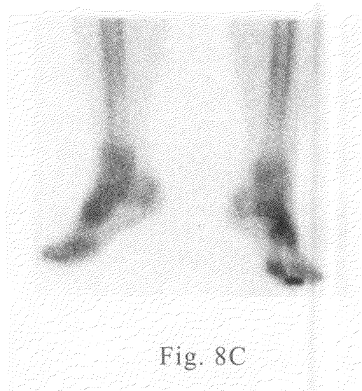

The following detailed descriptions provided the two embodiments of clinical experiments. The foregoing aspects and many of the attendant advantages of this invention will become more readily appreciated as the invention becomes better understood based on the following detailed description, taken in conjunction with the accompanying drawings, FIGS. 8A, 8B, 8C. The accompanying drawings and following embodiments are used for illustrative purposes rather than to limit the present invention.

### EXAMPLE I

In Example I, a 31 year old pregnancy woman frequently suffered from the paroxysmal pain due to a combination of work and family pressures. However, the anodyne is not suitable for administration either orally or by injection during pregnancy. The paroxysmal pain cannot be solved, but the pain frequency is highly and the duration is longer with time.

According to the related information, the abnormal portion indicate the body flow line II of the external portion of the right foot (Ying meridian), rAyII. In this case, the body flow line corresponds to the internal portion of the right hand (Yang meridian), rTxIII. Based on the information regarding the distributions of collateral meridians and the body flow lines, the C point can be indicated and determined by the stimulated point 1 of the internal portion of right hand, rTxIII. Moreover, the F point can also be indicated and determined by stimulated point c. To solve the obstruction in the body flow lines stimulation thus is provided on the both stimulated points to attenuate or recover the abnormal portion. Additionally, the stimulations include acupressure, massage, acupuncture, electric stimulation (ES), laser or improved chemical or nature articles.

In Example I, the stimulation frequency may be 1-2 times and the stimulation duration may be 1-2 minutes each time. Furthermore, the stimulation frequency and duration are described to illustrate the present invention without limiting it. The present invention can be modified and changed based on the different levels of the abnormal portion and conditions.

### EXAMPLE II

In Example II, the sympathetic blockade with local anesthetics is the “gold standard” treatment for a young male with the complex regional pain syndrome (CRPS), and the visual analogue scales (VAS) scores can be termed the secondary indictors. However, the unanticipated side effects, complications or sequelas are generally followed by the conventional anesthetic method.

According to the aspect and method of the present invention, the body flow lines corresponding to the abnormal portion can be identified, and after which stimulations are provided.

Refer to FIG. 8A, it illustrates the diagram of the visual analogue scale (VAS) scores over time for pre-stimulation, post-stimulation and pill treatment, well known prior art, according to Example II of the present invention. The X-axis indicates the time (months per unit), the left Y-axis indicates the visual analogue scales (VAS) scores and the right Y-axis indicates the analgesic pills (pills/day). In the drawing, the open boxes show the VAS scores before the stimulation, while the closed boxes show the VAS scores after the stimulation and the closed circle shows the VAS scores after the pill treatment. According to the diagram, after the stimulation, the VAS scores reduce over time and are lower than the VAS scores before the stimulation and after the pill treatment. Therefore, the stimulation provided by the present invention achieves rapid and sustained improvement over a period of months to attenuate the abnormal portion.

Additionally, the abnormal portion is treated via the three-phase bone scan, and the precise steps involved in which are not described owing to being well known. Refer to FIG. 8B, it illustrates a diagram of the three-phase bone scan before the stimulation according to Example II of the present invention. The drawing contains a shadowed area at in the ankle of left foot, which indicates that the corresponding body flow lines are blocked and result in the abnormal portion.

FIG. 8C diagrammatically illustrates the three-phase bone scan after the stimulation according to Example II of the present invention. In the drawing, the shadow almost disappears after the stimulation. It means that the blockade in the ankle of left foot is resolved, and the abnormal portion is attenuated to recover the normal portion.

Based on the embodiments, the present invention provides an effective and accurate method for determining the stimulated point to attenuate or recover the abnormal portion. Notably, the present invention can be applied in humans, but this does not represent a limitation in its scope. The present invention can also be applied to other various organisms that are equivalent to humans.

Compared with the prior art, the present invention has the following advantages. The present invention provides a method for determining the stimulated point of the human body to replace the method of prior art, combining the theory of the Ying-Yang and the five elements, 12 collateral meridians, the relationships of inter promotion and inter-restrict of Chinese medicine and pathologic physiology of modern medicine. The present invention also can be modified to change the stimulation types and the stimulated points based on the different levels of the abnormal portion. The present invention can avoid connecting directly with the abnormal portion, and can further resolve the blockade of the body flow lines to attenuate the abnormal portion.

One advantage of the present invention is that the present invention can be easily performed, and does not require any special technologies or instruments.

According to the aspects of the present invention, the frequency and duration of the stimulation and stimulated points can be modified and adjusted according the different level of pain conditions to decrease the obstruction in the body flow lines attenuate or recover the abnormal portion.

As will be understood by a person skilled in the art, the foregoing preferred embodiments of the present invention are illustrative of the present invention, rather than limiting the present invention. Having described the invention in connection with a preferred embodiment, modification will suggest itself to those skilled in the art. Thus, the invention is not to be limited by this embodiment. Rather, the invention is intended to cover various modifications and similar arrangements included within the spirit and scope of the appended claims, the scope of which should be accorded the broadest interpretation so as to encompass all such modifications and similar structures.

What is claimed is:

1. A method for determining stimulated points of human body, comprising:
defining distributions of a plurality of collateral meridians of human and a plurality of body flow lines;
constructing the related information regarding said collateral meridians and said body flow lines based on said distributions of said plurality of collateral meridians and said body flow lines;
identifying corresponding body flow fines based on said collateral meridians of abnormal portions;
determining one or a plurality of stimulated points based on said body flow lines and said corresponding information of abnormal positions; and
applying stimulations to said stimulated points for attenuating or recovering said abnormal portions.

2. The method in claim 1, wherein said step of defining the distributions of a plurality of collateral meridians of human is divided into a plurality of collateral meridians longitudinally and horizontally.

3. The method in claim 1, wherein said plurality of body flow lines are networks to communicate with said distributions of said plurality of collateral meridians in said human body.

4. The method in claim 1, wherein said body flow lines include Ying and Yang body flow lines.

5. The method in claim 1, wherein types of said abnormal portions include chronic and acute abnormal portions.

6. The method in claim 1, wherein said types of abnormal portions include local and central abnormal portions.

7. The method in claim 1, wherein said abnormal portions include the regions sensing pains.

8. The method in claim 7, wherein said regions sensing pains include head, limbs or trunk.

9. The method in claim 7, wherein said regions sensing pains include visceral organs or neural systems.

10. The method in claim 1, wherein said plurality of stimulated points can be the opposite portions of said abnormal portions.

11. The method in claim 1, wherein said plurality of stimulated points can be the corresponding portions of said abnormal portions.

12. The method in claim 1, wherein said plurality of stimulated points includes control stimulated points and function stimulated points.

13. The method in claim 12, wherein said control stimulated points is the stimulated points between said plurality of body flow lines.

14. The method in claim 12, wherein said function stimulated points are used for attenuating or recovering said abnormal portions.

15. The method in claim 1, wherein said stimulations include acupressure, massage, acupuncture, electric stimulation (ES), laser or the improved chemical or natural articles.

16. The method in claim 15, wherein said improved chemical or nature articles can be used externally or internally.
